(19) United States
(12) Patent Application Publication
(10) Pub. No.: US 2009/0244916 A1
(43) Pub. Date: Oct. 1, 2009

(54) Baby stroller safety lights

(76) Inventors: Laura Alma Conwell, Haslet, TX (US); Chadley Kent Conwell, SR., Haslet, TX (US)

Correspondence Address: Laura A. Conwell, 1116 Castle Top Dr, Haslet, TX, 76052, US

(21) Appl. No.: 12/006,575

(22) Filed: Mar. 26, 2008

(51) Int. Cl. F21V 21/28

(52) U.S. Cl. 362/464

(57) ABSTRACT

The present invention provides a safety light having an easily recognizable and illumination pattern. The safety light consists of a housing containing at least one group of secondary lighting elements arranged substantially around a primary lighting element. The lighting elements are covered by a translucent face having a central portion overlying the primary lighting element. Circuit means power the lighting elements such that the secondary lighting elements are illuminated in a rotating, flickering or pulsing sequence producing a distinct light pattern. The safety light is suitable for use in a wide variety of applications, including vehicles and recreational and service activities.

### BACKGROUND OF THE INVENTION

1. Field of Invention

This invention relates to carriers, carriages, strollers of small children as an additional safety feature.

2. Prior Art

No prior art found

### SUMMARY

This invention will enable people to push their children in a carrier that contains equipment that will alert oncoming traffic of the child and parents whereabouts with the use of light(s). This invention will be able to produce different light sequences as flicker, pulse, revolve, and continuous burn to alert others at a safe distance of the carriers location.

This invention will be easily attached and self powered by batteries.

### DRAWINGS

### Figures

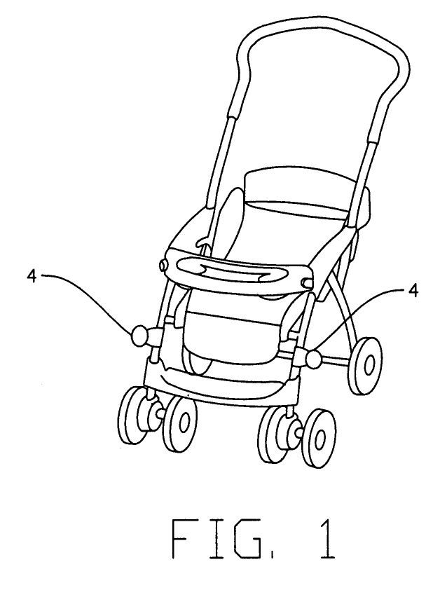

FIG. 1—One embodiment of a carriage with two Safety lights attached. Shown for viewers benefit

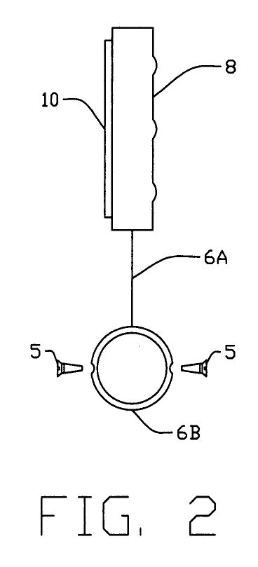

FIG. 2—Top view of 1 Safety Light on a crosscut view of a carriage frame with the front and rear attachment flange.

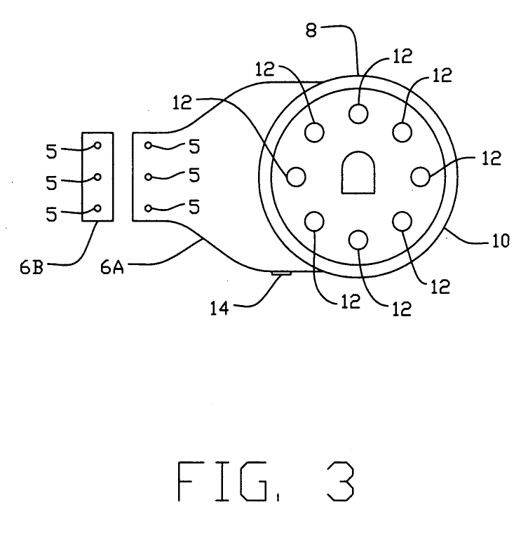

FIG. 3—Front view of Safety Light in accordance with one embodiment.

### REFERENCE NUMERALS

4 complete light assembly
5 sheet metal screw(s)
6 A. front attachment flange
   B. rear attachment flange
7 carriage frame
8 light and battery housing
10 front protective lens
12 bulb(s)
14 on/off switch

### DETAILED DESCRIPTION

FIG. 1 is a mock-up of one embodiment of two Safety Lights attached to a Stroller. The number of lights is up to the individual. A minimum of two would be preferred.

FIG. 2 is a top view of a light assembly. 10 is a lens for the bulb and battery housing-8. The attachment flange 6a and 6b is shown with a mockup of a carriage frame-7 shown. 6a and 6b are secured together by screws-5 that are long enough to go through the front attachment flange-6a through 7-carriage frame into 6b-rear attachment flange with sufficient length to be secured properly. Ideally 2-3 screws-5 are needed.

FIG. 3 is a frontal view of one embodiment with a circular Housing-8 and front protective lens-10.

Multiple Bulbs-12 are sufficient enough in power and brightness to project a beam that can be seen clearly at a sufficient distance to provide ample safety. The power is controlled by an on/off switch-14. As in FIG. 2, 6a the front attachment flange and 6b the rear attachment flange are secured together with enough 5-screws.

A person skilled in the art will be able to select suitable devices and power supplies according to the electrical and optical specifications for each device. The power supply chosen may be a battery, solar or rechargeable battery.

A number of embodiments of the invention have been described. Nevertheless, it will be understood that various modifications may be made without departing from the spirit and scope of the invention. Therefore, the spirit and scope of the claims should not be limited to the description of the version contained herein.

### CONCLUSION, RAMIFICATION, AND SCOPE OF INVENTION

A person will see that at least one embodiment of the Safety light assembly will provide an increased level of safety for its occupants.

While the above descriptions contain specific thoughts for usage this should not be misunderstood as limitations of the invention. But rather as a means for one of the multiple uses and different configurations this invention can encompass. A round safety light has been shown but square, rectangular, oblong of any size and dimension are possible and as efficient as the other.

What is claimed is:

1. A Safety light comprising:
At least one primary lighting element for directing light energy outward in a particular direction;
At least one group of secondary lighting elements arranged substantially around said primary lighting element for directing light energy outward in said particular direction, wherein at least one group of secondary lighting elements are mounted within said safety light so as to permit rotation, pulsing, continuous or flickering sequence of said secondary lighting elements about said primary lighting element;
A translucent face lying substantially on a plane perpendicular to said particular direction comprising a central portion overlying said primary lighting element.
Circuit means for illuminating said primary lighting element and said secondary lighting elements, said secondary lighting elements being illuminated in a particular sequence;
And housing means for housing said lighting elements said translucent face and said circuit means of said safety light.

2. The safety light of claim 1 wherein a first rotating secondary lighting element rotates about said primary lighting element while at least one other secondary lighting element rotates around said first rotating secondary lighting element.

3. A safety light comprising:
A central primary lighting element for directing light energy outward in a particular direction.
A first group of secondary lighting elements arranged substantially around said primary lighting element for directing light energy outward in said particular direction;
A second group of secondary lighting elements arranged substantially around said first group of secondary lighting elements for directing light energy outward in said particular direction, wherein each of said groups of secondary lighting elements comprises at least one secondary lighting element is mounted within said safety light so as to permit rotation, pulsing, continuous or flickering effect of said secondary lighting element about said primary lighting element.
A translucent face lying substantially in a plane perpendicular to said particular direction comprising a central portion overlying said primary lighting element are illuminated, light emitting from each of said secondary elements appears to a viewer in an effect as named above.
Circuit means for illuminating said primary lighting element and said secondary lighting elements, said first and second groups of secondary lighting elements being illuminated in a particular sequence.
And housing means for housing said primary and secondary lighting elements, batteries, and said translucent face and said circuit means of said safety light.
